(19) United States
(12) Patent Application Publication
(10) Pub. No.: US 2007/0200661 A1
(43) Pub. Date: Aug. 30, 2007

(54) RFID VISUAL BASED ACCESS CONTROL

(75) Inventor: Remi David BLUM, Holon (IL)

Correspondence Address: SIMON KAHN;c/o LANDONIP, INC, 1700 DIAGONAL ROAD, SUITE 450, ALEXANDRIA, VA, 22314-2866, US

(73) Assignee: IMMOTEC SECURITY SYSTEMS LTD., Holon (IL)

(21) Appl. No.: 11/690,832

(22) Filed: Mar. 25, 2007

Related U.S. Application Data
(63) Continuation-in-part of application No. 11/627,973, filed on Jan. 28, 2007.
(60) Provisional application No. 60/762,900, filed on Jan. 30, 2006.

(51) Int. Cl. G05B 19/00

(52) U.S. Cl. 340/5.25; 340/5.61; 340/5.24

(57) ABSTRACT

A method of proximity access control comprising: defining a master proximity key exhibiting a particular visual encoding; defining at least one additional proximity key exhibiting a particular visual encoding different than the particular visual encoding exhibited by the master proximity key; detecting the master proximity key; detecting one of the at least one additional proximity key contemporaneously with the detected master proximity key; and enabling the detected additional proximity key, the enabling being associated with the particular visual encoding. An identifier of the visual encoding is preferably stored on each proximity key. Preferably, the visual encoding is constituted of color coding, and only a single proximity key of each color is thus authorized.

### CROSS-REFERENCE TO RELATED APPLICATIONS

This application is a continuation-in-part of U.S. patent application Ser. No. 11/627,973 filed Jan. 28, 2007 entitled “Integrated Interphone and RFID Access Control Encoder”, which claims priority from U.S. Provisional Patent Application Ser. No. 60/762,900 filed Jan. 30, 2006 entitled “Integrated Interphone and RFID Access Control Encoder”, the entire contents of both of which are incorporated herein by reference.

### BACKGROUND OF THE INVENTION

The invention relates generally to the field of proximity access control for dwellings and in particular to a method of encoding proximity keys in cooperation with a master proximity key.

Proximity keys, also known as key fobs or proximity key tags, are gaining in popularity for use in access control. Proximity keys typically operate via radio frequency identification, or RFID, and are covered under a number of international standards such as ISO 14443 and ISO 15693 published by the International Organization for Standardization, Geneva, Switzerland, the entire contents of both of which are incorporated herein by reference.

One use for proximity keys is to control access to a multi-dwelling, in which a plurality of dwellers are each to be supplied with a proximity key. A system utilizing proximity keys must provide for a method and means for enabling, or authorizing, a plurality of proximity keys both for original issue and in the event of a lost proximity key. Typically, enabling a proximity key is accomplished by encoding a blank proximity key with an identifier code. Furthermore, preferably each dweller of each dwelling is provided with a separately identified proximity key, so that replacement and cancellation of a lost or misplaced proximity key of one dweller does not inconvenience other dwellers of the dwelling.

Preferably, a single proximity key provides access to both the multi-dwelling site and the individual dwelling. In prior art systems, a single proximity key identifier code is used to both enable access to the multi-dwelling site and the individual dwelling. Unfortunately, security in such a system is compromised, as access to the multi-dwelling site database is sufficient to enable access to each and every dwelling in the site.

Proximity key systems according to the prior art are typically provided with proximity key encoders or programmers, which are typically attached to a computer and are operative to encode a blank proximity key with an identifier code thereby enabling, or authorizing, the proximity key. Such a system is not ideal in that it requires connection to a computer and technical knowledge in order to enable proximity keys. Additionally, identification of a lost proximity key is problematic, typically resulting in the need to disable all proximity keys, and then reauthorizing the remaining proximity keys.

Alternatively, replacement proximity keys are sold together as a set with an access control reader, also called a read write device (RWD), and dedicated add and delete cards are supplied to authorize, or disable a particular proximity key. Unfortunately, in such an embodiment no convenient method of disabling a particular lost proximity key is provided and instead all outstanding proximity keys must be disabled, and the remaining proximity keys individually reauthorized. Such a system is cumbersome and may result in a dweller, absent during the reauthorization process, being denied access to the dwelling.

Another alternative prior art embodiment provides for the RWD to identify a first proximity key as the master. Other proximity keys may be added, that is enabled or authorized, or deleted, that is disabled or unauthorized, by being placed in proximity of the RWD during a predetermined time period after recognition by the RWD of the master. Unfortunately, there is no means of canceling a lost proximity key, since it is not available to be presented to the RWD in combination with the master, and instead all proximity keys in the system require reauthoriztion.

There is thus a long felt need for an improved controlled access system providing for ease of replacement for lost proximity keys. Preferably, such a system further provides for separate means of identification for access to a multi-dwelling site and to the respective individual dwelling.

### SUMMARY OF THE INVENTION

Accordingly, it is a principal object of the present invention to overcome the disadvantages of prior art controlled access systems. This is provided in the present invention by a method of visually encoding proximity keys. A particular visual encoding defines a master, and a plurality of visual encodings, different than the visual encoding defining the master proximity key, defines additional proximity keys. An identifier of the visual encoding is stored in the non-volatile memory of the proximity key as well as a unique identifier of the proximity key. In one embodiment, a plurality of master proximity keys is defined.

When an RWD is initialized, it awaits detection of a master proximity key. Upon detection of a first master proximity key, identified as a master proximity key by the visual encoding identifier stored thereon, the RWD stores the unique identifier of the master proximity key in a memory, preferably a non-volatile memory, and preferably sets a flag indicating that a master proximity key has been identified. In one embodiment, detection of a second master proximity key is ignored. In another embodiment, one or more additional master proximity keys may be similarly identified and the unique identifier stored in memory. In another embodiment, the RWD loads the master proximity key with an identifier, the identifier being used in place of the unique identifier of the master proximity key, which need not be supplied.

Authorization of additional proximity keys is accomplished in cooperation with the one or more master proximity key. Upon detection of a master proximity key and contemporaneously an additional proximity key, the additional proximity key being visually encoded differently from the master proximity key, an identifier of the visual encoding being stored therein, the RWD stores the identifier of the additional proximity key associated with the identifier of the visual encoding in an authorized key memory thereby authorizing the proximity key. Preferably, a plurality of visual encodings are supplied, and only a single proximity key of a particular visual encoding is authorized on the RWD by being stored in the authorized key memory.

In the event of a lost key, a replacement key of the same visual encoding as the lost key is obtained. Authorization, as describe above, automatically disables the lost proximity key by storing the identifier of the replacement proximity key associated with the particular visual encoding, in place of the identifier of the lost proximity key.

In a preferred embodiment, the visual encoding is by color, and thus a master proximity key is supplied exhibiting a particular color, and additional proximity keys are supplied in a plurality of colors other than that of the master proximity key. Preferably, only a single proximity key of a particular color may be authorized by the RWD, and lost proximity keys are easily replaced, and disabled, by a proximity key of the same color encoded in cooperation with the master proximity key. Visual encoding is preferred for ease of recall of the visual encoding of the lost proximity key.

Access to a multi-dwelling site is preferably performed in cooperation with an RWD. The multi-dwelling site RWD preferably does not access the unique identifier of the proximity keys utilized to access individual dwellings.

As indicated above, master proximity keys in accordance with a principle of the invention exhibit a particular visual encoding, an identifier of the visual encoding being stored therein. In one embodiment, the master proximity key, or proximity keys, of each dwelling is further encoded with site information, certain dwelling information and a date/time stamp. The certain dwelling information is encoded in cooperation with a user input, the user input identifying to the multi-dwelling RWD, or encoder, certain dwelling information such as unit number or registered name for the master proximity key. The date/time stamp stored on the master proximity key is further stored as an identifier on the authorized master proximity key database of the multi-dwelling site associated with the multi-dwelling site RWD, the date/time stamp being stored on the authorized master proximity key database associated with the certain dwelling information. In another embodiment a unique identifier is utilized in place of the date/time stamp, the unique identifier being different than the unique identifier associated with access to the dwelling. In one further embodiment the unique identifier is stored on the master proximity key as part of an initial production process, and in another embodiment the unique identifier is sourced from one of the multi-dwelling site RWD, the encoder, and the authorized master proximity key database.

Additional proximity keys for the dwelling are authorized in cooperation with master proximity key as described above. In particular, upon detection of a master proximity key, whose date/time stamp or other identifier matches a date/time stamp stored as an identifier, or other identifier, on an authorized master proximity key database, and contemporaneously an additional proximity key, the additional proximity key being visually encoded differently from the master proximity key and an identifier of the visual encoding being stored therein, the RWD, or encoder, stores on the additional proximity key a date/time stamp, site information and certain dwelling information. The RWD, or encoder, further stores on an authorized additional proximity key database the date/time stamp associated with the identifier of the visual encoding of the proximity key and the certain dwelling information. Preferably, a plurality of visual encodings are supplied, and only a single proximity key of a particular visual encoding is authorized on the RWD by being stored in the authorized proximity key database. Thus, lost proximity keys are easily replaced, and disabled, by a proximity key of the same color encoded in cooperation with the master proximity key of the particular dwelling. In another embodiment a unique identifier is utilized in place of the date/time stamp, the unique identifier being different than the unique identifier associated with access to the dwelling.

The invention provides for a method of proximity access control comprising: defining a master proximity key exhibiting a particular visual encoding; defining at least one additional proximity key exhibiting a particular visual encoding different than the particular visual encoding exhibited by the master proximity key; detecting the master proximity key; detecting one of the at least one additional proximity keys contemporaneously with the detected master proximity key; and enabling the detected additional proximity key, the enabling being associated with the particular visual encoding.

In one embodiment the defining a master proximity key comprises: visually encoding the master proximity key with the exhibited particular visual encoding; and storing an identifier of the visual encoding on the master proximity key. In another embodiment the defining a master proximity key further comprises: storing a unique identification code on the master proximity key.

In one embodiment the defining at least one additional proximity key comprises: visually encoding the at least one additional proximity key with the particular visual encoding; and storing an identifier of the visual encoding on the at least one additional proximity key. In another embodiment the defining at least one additional proximity key further comprises: storing a unique identification code on the at least one additional proximity key.

In one further embodiment the enabling comprises: reading the stored unique identification code of the detected additional proximity key; reading the identifier of the visual encoding of the detected additional proximity key; and storing the read unique identification code associated with the read identifier of the visual encoding on an authorized proximity key database. In one yet further embodiment the enabling further comprises: enabling entry responsive to the stored unique identification code. In another yet further embodiment, in the event that the read identifier of the visual encoding of the detected additional proximity key is the same as a previously stored identifier of the visual encoding stored on the authorized key database associated with a previously stored unique identification code, the storing of the read unique identification code associated with the read identifier of the visual encoding on the authorized proximity key database disables a proximity key exhibiting the previously stored unique identification code.

In one embodiment the at least one additional proximity key comprises a plurality of additional proximity keys, the particular visual encoding of each of the plurality of additional proximity keys being different than the particular visual encoding of all others of the plurality of additional proximity keys. In another embodiment the particular visual encoding is constituted of a particular color.

The invention independently provides for an access control system comprising: a read write device; a master proximity key exhibiting a particular visual encoding; and at least one additional proximity key exhibiting a particular visual encoding different than the particular visual encoding exhibited by the master proximity key, the read write device being operative to: detect the master proximity key; detect one of the at least one additional proximity key contemporaneously with the detected master proximity key; and enable the detected additional proximity key associated with the particular visual encoding.

In one embodiment the master proximity key comprises a stored identifier of the visual encoding. In another embodiment the master proximity key further comprises a stored unique identification code.

In one embodiment the at least one additional proximity key comprises a stored identifier of the particular visual encoding. In another embodiment each of the at least one additional proximity key further comprises a stored unique identification code.

In one further embodiment the operation to enable the detected additional proximity key comprises: read the stored unique identification code of the detected additional proximity key; read the stored identifier of the visual encoding of the detected additional proximity key; and store the read unique identification code associated with the read stored identifier of the visual encoding. In one yet further embodiment the operation to enable the detected additional proximity key further comprises: enable entry responsive to the stored read unique identification code. In another yet further embodiment, in the event that the read identifier of the visual encoding of the detected additional proximity key is the same as a previously stored identifier of the visual encoding stored on the authorized key database associated with a previously stored unique identification code, the storing of the read write device of the read unique identification code associated with the read identifier of the visual encoding on the authorized proximity key database disables a proximity key exhibiting the previously stored unique identification code. In yet another further embodiment the operation to enable the detected additional proximity key comprises: store a unique identification code on the detected additional proximity key; read the stored identifier of the visual encoding of the detected additional proximity key; and store the unique identification code associated with the read stored identifier of the visual encoding.

In one embodiment the at least one additional proximity key comprises a plurality of additional proximity keys, the particular visual encoding of each of the plurality of additional proximity keys being different than the particular visual encoding of all others of the plurality of additional proximity keys. In another embodiment the particular visual encoding is constituted of a particular color.

The invention independently provides for a method of proximity access control for a multiple dwelling site comprising: defining a plurality of master proximity keys exhibiting a common particular visual encoding; storing an identifier of the visual encoding on each of the plurality of master proximity keys; storing on each of the defined plurality of master proximity keys site information, dwelling information and one of a date/time stamp and a unique identifier; defining a plurality of additional proximity keys each exhibiting a visual encoding different than the particular visual encoding exhibited by the plurality of master proximity keys; storing an identifier of the respective visual encoding of each of the additional proximity keys on the respective additional proximity key; detecting one of the plurality of master proximity keys; detecting one of the at least one additional proximity key contemporaneously with the detected one of the master proximity keys; reading from the one of the plurality of master proximity keys the site information, dwelling information, and the one of the date/time stamp and the unique identifier; reading from the detected one additional proximity key the stored identifier of the respective visual encoding; storing on the detected one additional proximity key the read site information, the dwelling information and one of a current date/time stamp and a unique identifier; storing on a database of authorized additional proximity keys the one of the current data/time stamp and the unique identifier associated with the read dwelling information and the identifier of the visual encoding of the detected one additional proximity key; and enabling entry responsive to the database of authorized proximity keys.

In one embodiment the enabling entry comprises: detecting one of the at least one additional proximity keys; reading from the detected one additional proximity key the site information, the dwelling information and the one of a current date/time stamp and a unique identifier; and enabling entry in the event the read site information, the read dwelling information and the read one of a current date/time stamp and a unique identifier corresponds with those stored on the database. In another embodiment the unique identifier is not used to access individual dwellings.

Independently, the invention provides for a system for access to a multiple dwelling site, the system comprising: a read write device; a data base associated with the read write device; a plurality of master proximity keys, each associated with a particular dwelling of the multiple dwelling site and exhibiting a common particular visual encoding and each exhibiting a stored identifier of the visual encoding, each of the plurality of master keys further having stored thereon site information, dwelling information regarding the particular dwelling and one of a date/time stamp and a unique identifier; a plurality of additional proximity keys each exhibiting a visual encoding selected from a plurality of visual encodings different than the particular visual encoding exhibited by the plurality of master proximity keys and each exhibiting a stored identifier of the selected visual encoding; the read write device being operative to: detect one of the plurality of master proximity keys; detect one of the at least one additional proximity key contemporaneously with the detected one of the master proximity keys; read from the one of the plurality of master proximity keys the site information, dwelling information, and the one of the date/time stamp and the unique identifier; read from the detected one additional proximity key the stored identifier of the respective visual encoding; store on the detected one additional proximity key the read site information, the dwelling information and one of a current date/time stamp and a unique identifier; and store on the database the one of the current data/time stamp and the unique identifier associated with the read dwelling information and the read identifier of the selected visual encoding of the detected one additional proximity key.

In one embodiment the database is arranged to store for each dwelling no more than one of the current data/time stamp and the unique identifier associated with each identifier of the plurality of visual encodings. In another embodiment the read write device is further operative to: detect one of the at least one additional proximity keys; read from the detected one additional proximity key the site information, the dwelling information and the one of a current date/time stamp and a unique identifier; and enable entry in the event the read site information, the read dwelling information and the read one of a current date/time stamp and a unique identifier corresponds with one of those stored on the database. In yet another embodiment the unique identifier is not used to access individual dwellings.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates an embodiment of a proximity access control system exhibiting an RWD in accordance with a principle of the invention;

FIG. 2 illustrates a high level flow chart of a method of encoding proximity keys with a visual indicator, in accordance with a principle of the invention;

FIG. 3 illustrates a high level flow chart of the operation of the RWD of FIG. 1 to identify a master proximity key exhibiting a predetermined visual encoding in accordance with a principle of the invention;

FIG. 4 illustrates a high level flow chart of the operation of the RWD of FIG. 1 to authorize additional proximity keys having visual encoding different than the predetermined visual encoding of the master proximity key, in accordance with a principle of the invention, preferably only authorizing a single additional proximity key of each particular visual encoding;

FIG. 5 illustrates a high level block diagram of a multi-dwelling RWD implemented as an interphone panel exhibiting a database of authorized master proximity keys, authorized other proximity keys and site information in accordance with a principle of the invention; and

FIG. 6 illustrates a high level flow chart of the operation of the multi-dwelling RWD of FIG. 5 to authorize proximity keys in accordance with a principle of the invention.

### DETAILED DESCRIPTION OF THE PREFERRED EMBODIMENTS

The present embodiments enable a method of visually encoding proximity keys. A particular visual encoding defines a master, and a plurality of visual encodings, different than the visual encoding defining the master proximity key, defines additional proximity keys. An identifier of the visual encoding is stored in the non-volatile memory of the proximity key as well as a unique identifier of the proximity key. In one embodiment, a plurality of master proximity keys is defined.

When an RWD is initialized, it awaits detection of a master proximity key. Upon detection of a first master proximity key, identified as a master proximity key by the visual encoding identifier stored thereon, the RWD stores the unique identifier of the master proximity key in a memory, preferably a non-volatile memory, and preferably sets a flag indicating that a master proximity key has been identified. In one embodiment, detection of a second master proximity key is ignored. In another embodiment, one or more additional master proximity keys may be similarly identified and the unique identifier stored in memory. In another embodiment, the RWD loads the master proximity key with an identifier, the identifier being used in place of the unique identifier of the master proximity key, which need not be supplied.

Authorization of additional proximity keys is accomplished in cooperation with the one or more master proximity key. Upon detection of a master proximity key and contemporaneously an additional proximity key, the additional proximity key being visually encoded differently from the master proximity key, an identifier of the visual encoding being stored therein, the RWD stores the identifier of the additional proximity key associated with the identifier of the visual encoding in an authorized key memory thereby authorizing the proximity key. Preferably, a plurality of visual encodings are supplied, and only a single proximity key of a particular visual encoding is authorized on the RWD by being stored in the authorized key memory.

In the event of a lost key, a replacement key of the same visual encoding as the lost key is obtained. Authorization, as describe above, automatically disables the lost proximity key by storing the identifier of the replacement proximity key associated with the particular visual encoding, in place of the identifier of the lost proximity key.

In a preferred embodiment, the visual encoding is by color, and thus a master proximity key is supplied exhibiting a particular color, and additional proximity keys are supplied in a plurality of colors other than that of the master proximity key. Preferably, only a single proximity key of a particular color may be authorized by the RWD, and lost proximity keys are easily replaced, and disabled, by a proximity key of the same color encoded in cooperation with the master proximity key. Visual encoding is preferred for ease of recall of the visual encoding of the lost proximity key.

Access to a multi-dwelling site is preferably performed in cooperation with an RWD. The multi-dwelling site RWD preferably does not access the unique identifier of the proximity keys utilized to access individual dwellings.

As indicated above, master proximity keys in accordance with a principle of the invention exhibit a particular visual encoding, an identifier of the visual encoding being stored therein. In one embodiment, the master proximity key, or proximity keys, of each dwelling is further encoded with site information, certain dwelling information and a date/time stamp. The certain dwelling information is encoded in cooperation with a user input, the user input identifying to the multi-dwelling RWD, or encoder, certain dwelling information such as unit number or registered name for the master proximity key. The date/time stamp stored on the master proximity key is further stored as an identifier on the authorized master proximity key database of the multi-dwelling site associated with the multi-dwelling site RWD, the date/time stamp being stored on the authorized master proximity key database associated with the certain dwelling information. In another embodiment a unique identifier is utilized in place of the date/time stamp, the unique identifier being different than the unique identifier associated with access to the dwelling. In one further embodiment the unique identifier is stored on the master proximity key as part of an initial production process, and in another embodiment the unique identifier is sourced from one of the multi-dwelling site RWD, the encoder, and the authorized master proximity key database.

Additional proximity keys for the dwelling are authorized in cooperation with master proximity key as described above. In particular, upon detection of a master proximity key, whose date/time stamp or other identifier matches a date/time stamp stored as an identifier, or other identifier, on an authorized master proximity key database, and contemporaneously an additional proximity key, the additional proximity key being visually encoded differently from the master proximity key and an identifier of the visual encoding being stored therein, the RWD, or encoder, stores on the additional proximity key a date/time stamp, site information and certain dwelling information. The RWD, or encoder, further stores on an authorized additional proximity key database the date/time stamp associated with the identifier of the visual encoding of the proximity key and the certain dwelling information. Preferably, a plurality of visual encodings are supplied, and only a single proximity key of a particular visual encoding is authorized on the RWD by being stored in the authorized proximity key database. Thus, lost proximity keys are easily replaced, and disabled, by a proximity key of the same color encoded in cooperation with the master proximity key of the particular dwelling. In another embodiment a unique identifier is utilized in place of the date/time stamp, the unique identifier being different than the unique identifier associated with access to the dwelling.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

FIG. 1 illustrates an embodiment of a proximity access control system 10 in accordance with a principle of the invention comprising: an RWD 20; and access control 30; a master proximity key 40; and a plurality of additional proximity keys 50. RWD 20 comprises a control circuitry 55 and a memory 60 in communication with control circuitry 55. Memory 60 is segregated into an authorized proximity key memory 70, a master proximity key ID location 80 and a master received flag 90. Access control 30, depicted as a door lock and handle, comprises RWD antenna 100 and a mechanical key slot 110. RWD antenna 100 is in communication with control circuitry 55. Access control 30 is responsive to an output of control circuitry 55 to enable access, and typically comprises one of an electric strike, a magnetic strike, electric latch bolt and a magnetic latch bolt. Mechanical key slot 110 enables manual entry in case of power or system failure.

Master proximity key 40 comprises a read/write electronics 120 and a configurable memory 130 in communication therewith, and exhibits a predetermined visual encoding 140. Each of the plurality of additional proximity keys 50 comprises a read/write electronics 120 and a configurable memory 130 in communication therewith, and exhibits a particular visual encoding 145. In particular, each of the plurality of additional proximity keys 50 exhibits a visual encoding 145 different from the visual encoding 145 of all other additional proximity keys 50 in system 10 and different from the predetermined visual encoding 140 of master proximity key 40. An identifier of the predetermined visual encoding 140 of master proximity key 40 is stored on configurable memory 130 of master proximity key 40 and an identifier of the particular visual encoding 145 of each additional proximity key 50 is stored on configurable memory 130 of the respective additional proximity key 50. A unique identification coding, preferably comprising a serial number, is further stored on configurable memory 130 of each of the respective master proximity key 40 and additional proximity keys 50. Thus, configurable memory 130 has stored thereon an identification of visual encoding 140, 145, respectively, and a unique identification code.

In an exemplary embodiment visual encoding 140, 145, respectively, is constituted of color coding, and thus master proximity key 40 exhibits a predetermined color, and each of the additional proximity keys 50 exhibits a color different from the color of all other additional proximity keys 50 and different from the predetermined color of master proximity key 40. As described above, an identifier of the predetermined color of master proximity key 40 and the color of each additional proximity key 50 is stored in the respective configurable memory 130.

In operation, RWD 20 detects the proximity of master proximity key 40 and identifies master proximity key 40 as a master proximity key responsive to the stored identifier of the predetermined visual encoding 140 of master proximity key 40. In the event that master proximity key 40 is the first master proximity key 40 detected by RWD 20, as indicated by the status of master received flag 90, RWD 20 reads the unique identification code from configurable memory 130 and stores the unique identification code in master proximity key ID location 80. In another embodiment, RWD 20 loads the master proximity key with an identifier code, the identifier code being used in place of the unique identifier of the master proximity key, which need not be supplied. In one embodiment the identifier code is generated by RWD 20 and in another embodiment the identifier is a unique identifier associated with RWD 20.

To authorize one or more additional proximity key 50, RWD 20 detects the proximity of an additional proximity key 50 contemporaneously with the proximity of master proximity key 40. RWD 20 stores the unique identification code of the additional proximity key 50 associated with the identifier of the visual encoding 145 of the additional proximity key 50 in authorized proximity key memory 70. Thus, for each particular visual encoding 145 only a single unique identification code of an additional proximity key 50 is stored in authorized proximity key memory 70, and thus for each particular visual encoding 145 only a single proximity key 50 is authorized. In one embodiment, RWD 20 generates an identifier code, stores the identifier code on additional proximity 40 in place of the unique identification code, which need not be supplied, and further stores the generated identifier code as the unique identification code associated with the identifier of the visual encoding 145 of the additional proximity key 50 in authorized proximity key memory 70. RWD 20 may generate the code responsive to a date/time stamp, a list of pre-stored codes, or a predetermined offset from a unique identifier without exceeding the scope of the invention.

In the event of a lost additional proximity key 50, a replacement additional proximity key 50 exhibiting the particular visual encoding 140 of the lost key is placed in proximity of RWD 20 contemporaneously with the proximity of master proximity key 40. The unique identification code of the replacement additional proximity key 50 is thus stored in authorized proximity key memory 70 associated with the particular visual encoding 145 of the replacement additional proximity key 50. In an embodiment in which RWD 20 generates the code to be used as a unique identification code, the code to be used is preferably not a code previously used by RWD 20. Thus, the unique identification code of the lost additional proximity key 50 is no longer found in authorized proximity key memory 70 and access for the lost additional proximity key 50 will be denied.

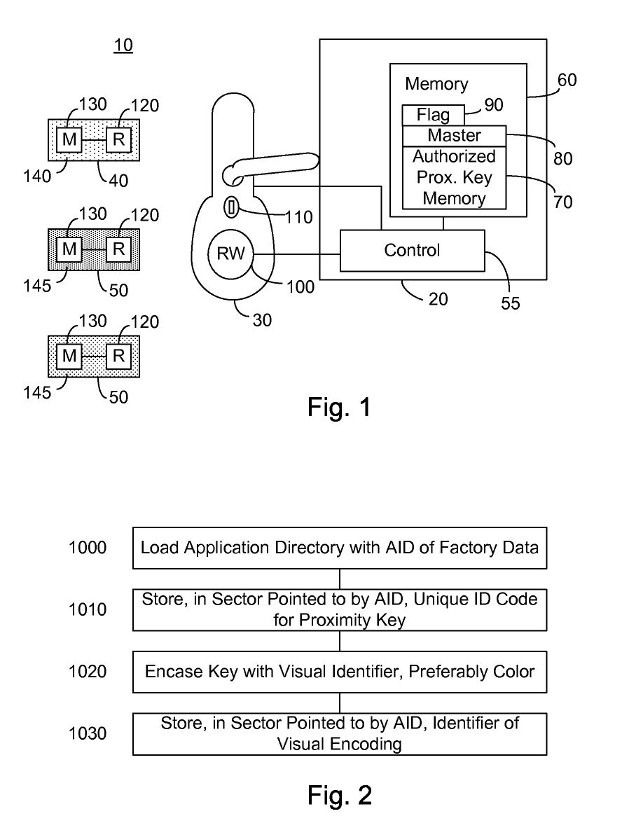

FIG. 2 illustrates a high flow chart of a method of encoding proximity keys with a visual indicator 140, 145, respectively, in accordance with a principle of the invention. In stage 1000, the application directory of configurable memory 130 is loaded with the application identifier of the respective factory data. In stage 1010, a unique identification code for the proximity key is stored in the memory sector pointed to by the application identifier of stage 1000. In one embodiment stage 1010 is optional, and instead RWD 20 generates an identification code, or is loaded with a unique identification code and stores the identification code in a memory sector as described above.

In stage 1020, the proximity key is encased with a visual encoding 140, 145, respectively. In an exemplary embodiment visual encoding 140, 145, respectively, is a particular color. In stage 1030, an identifier of visual encoding 140, 145, respectively, applied in stage 1020 is stored in the memory sector pointed to by the application identifier of stage 1000.

Thus, the method of the FIG. 2 produces a proximity key having encoded thereon, in an identified sector of configurable memory 130, an indicator of the visual encoding 140, 145, respectively, of the proximity key and optionally a unique identification code.

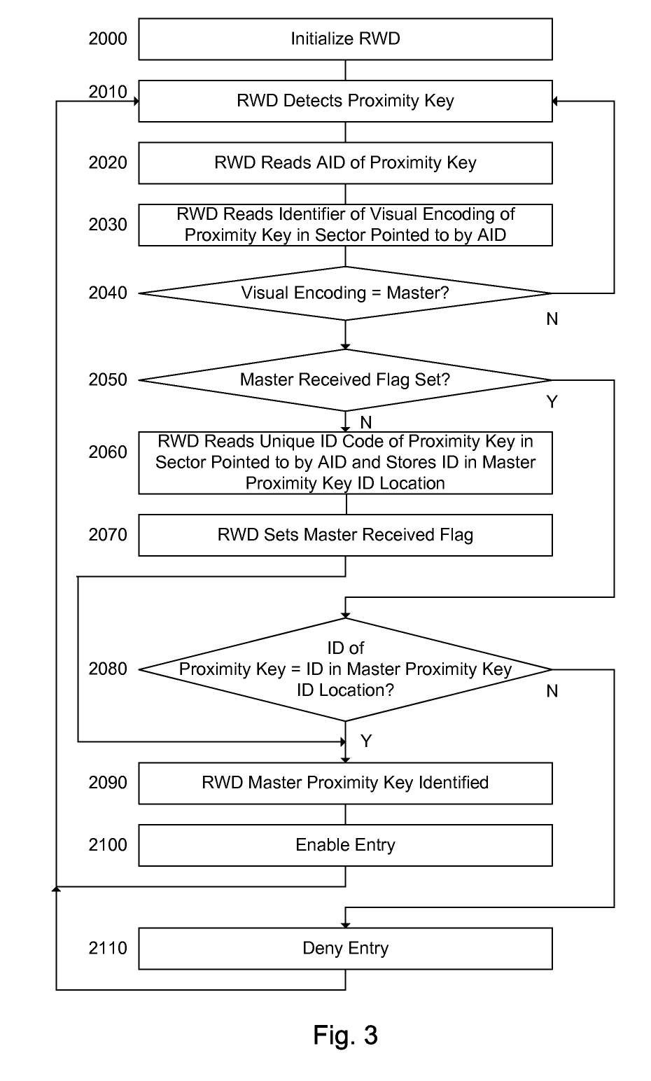

FIG. 3 illustrates a high level flow chart of the operation of RWD 20 of FIG. 1 to identify a master proximity key 40 responsive to the predetermined visual encoding in accordance with a principle of the invention. In stage 2000, RWD 20 initializes and clears flag 90, authorized proximity key memory 70 and master proximity key ID location 80 of memory 60. In stage 2010, RWD 20 detects a proximity key which may be one of master proximity key 40 and an additional proximity key 50. In stage 2020, RWD 20 reads the application identifier of the detected proximity key of stage 2010. In stage 2030, responsive to the application identifier read in stage 2020, RWD 20 reads the identifier of the visual encoding 140, 145, respectively, stored on configurable memory 130.

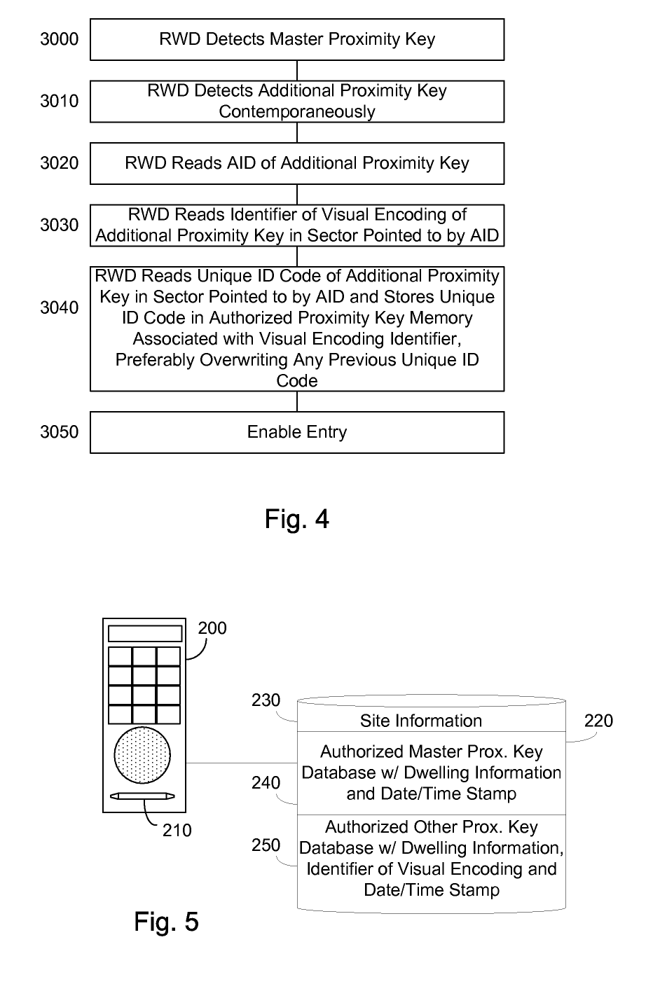

In stage 2040, the identifier of the visual encoding 140, 145, respectively, read in stage 2030 is compared with the predetermined visual encoding 140 associated with a master proximity key 40. In the event that the visual encoding 140, 145, respectively, read in stage 2030 is not indicative of a master proximity key 40, i.e. it is visual encoding 145, stage 2010 described above is performed when another proximity key is detected. In the event that the visual encoding 140, 145, respectively, read in stage 2030 is indicative of a master proximity key 40, i.e. it is visual encoding 140, in stage 2050 master received flag 90 is checked to see if it is set. In the event that master received flag 90 is not set, i.e. no master proximity key 40 has been previously detected, in stage 2060 RWD 20 reads unique identification code from configurable memory 130 of master proximity key 40 detected in stage 2010, and stores the read unique identification code in master proximity key ID location 80. In another embodiment, RWD 20 loads the master proximity key with a unique identifier, the unique identifier being used in place of the unique identifier of the master proximity key, which need not be supplied. In stage 2070, RWD 20 sets master received flag 90. In stage 2090, RWD 20 has identified a master proximity key 40, as will be described further below in relation to stage 3000 of FIG. 4. In stage 2100, RWD 20 enables entry by operating access control 30. Stage 2010 described above is performed when another proximity key is detected.

In the event that in stage 2050 master received flag 90 is set, i.e. a master proximity key 40 has been previously detected, in stage 2080 RWD 20 reads the unique identification code stored on configurable memory 130 of master proximity key 40 detected in stage 2010, responsive to the application identifier of stage 2020, and compares it with the contents of master proximity key ID location 80. In the event that the unique identification code stored on configurable memory 130 of master proximity key 40 detected in stage 2010 is equal to the contents of master proximity ID location 80, stage 2090 described above is again performed.

In the event that in stage 2080 the unique identification code stored on configurable memory 130 of master proximity key 40 detected in stage 2010 is not equal to the contents of master proximity ID location 80, in stage 2110 entry is denied. Stage 2010 described above is performed when another proximity key is detected.

Thus, the method of FIG. 3 identifies a first appearing master proximity key 40, and stores the unique identification code thereof in master proximity key ID location 80. The method further identifies a further appearance of the first appearing master proximity key 40 and denies entry to any other master proximity key 40.

FIG. 4 illustrates a high level flow chart of the operation of RWD 20 of FIG. 1 to authorize additional proximity keys having visual encoding different than the predetermined visual encoding of master proximity key 40, in accordance with a principle of the invention, preferably only authorizing a single additional proximity key 50 of each particular visual encoding 145. In stage 3000, RWD 20 detects master proximity key 40 as described above in relation to FIG. 3. In stage 3010, RWD 20 detects the proximity of an additional proximity key 50 contemporaneously with the proximity of master proximity key 40. In stage 3020, RWD 20 reads the application identifier of additional proximity key 50 detected in stage 3010.

In stage 3030, responsive to the application identifier of stage 3020, RWD 20 reads the identifier of visual encoding 145 of additional proximity key 50 detected in stage 3010. In stage 3040, RWD 20, responsive to the application identifier of stage 3020, reads unique identification code of additional proximity key 50 detected in stage 3010 and stores the unique identification code in authorized proximity key memory 70 associated with the identifier of visual encoding 145 read in stage 3030. Preferably, only a single unique identification code is stored associated with each identifier of visual encoding 145. Thus, any previously stored unique identification code associated with the identifier of visual encoding 145 read in stage 3030 is overwritten. In stage 3050 RWD 20 enables entry by operating access control 30. In one embodiment, RWD 20 generates an identifier code, stores the identifier code on additional proximity 40 in place of the unique identification code, which need not be supplied, and further stores the generated identifier code as the unique identification code associated with the identifier of the visual encoding 145 of the additional proximity key 50 in authorized proximity key memory 70 as described in stage 3040. RWD 20 may generate the code responsive to a date/time stamp, a list of pre-stored codes, or a predetermined offset from a unique identifier without exceeding the scope of the invention. Preferably, the code generated by RWD 20 is unique in that it is not a code previously used by RWD 20.

The method of FIG. 4 thus enables access for each particular visually encoded additional proximity key 50, and disables any previous additional proximity key 50 exhibiting the same particular visual encoding.

FIG. 5 illustrates a high level block diagram of a multi-dwelling RWD implemented as an interphone panel 200 exhibiting a proximity key reader/encoder 210 and a database 220, database 220 comprising: site information 230; a database of authorized master proximity keys 240; and a database of authorized other proximity keys 250 in accordance with a principle of the invention. Preferably, interphone panel 200 is as described in co-pending U.S. patent application Ser. No. 11/672,973 to Blum, filed Jan. 28, 2007 entitled “Integrated Interphone and RFID Access Control Encoder”, the entire contents of which is incorporated herein by reference. Proximity key reader/encoder 210 of interphone panel 200 is operative to detect a master proximity key 40 and read there from an identifier of the visual encoding defining the proximity key 40 as a master proximity key. Interphone panel 200 is further operative to load certain dwelling and site information into detected master proximity key 40. Interphone panel 200 is further operative to load a current date/time stamp into a non-volatile memory portion of master proximity key 40. In another embodiment, a unique identifier not associated with the identifier of stage 1010 of FIG. 2 is stored at time of manufacture in a non-volatile memory of master proximity key 40. Interphone panel 200 stores the loaded current date/time stamp, or unique identifier, respectively, associated with the certain dwelling information on database of authorized master proximity keys 240.

Interphone panel 200 is further operative to detect the proximity of an additional proximity key 50 contemporaneously with the proximity of a master proximity key 40. Interphone panel 200 reads site information from the detected master proximity key 40, and if it matches site information 230 stored on database 220, interphone panel 200 further reads dwelling information from master proximity key 40 and preferably stores the site information and dwelling information on the detected additional proximity key 50. Interphone panel 200 further reads the identifier of the visual encoding from additional proximity key 50 and stores a current date/time stamp in a non-volatile memory of additional proximity key 50. In another embodiment, a unique identifier not associated with the identifier of stage 1010 of FIG. 2 is stored at time of manufacture in a non-volatile memory of additional proximity key 50. Interphone panel 200 stores the loaded current date/time stamp, or unique identifier, respectively, associated with the dwelling information and identifier of the visual encoding on database of authorized other proximity keys 250. Preferably, only a single instance of each of the plurality of particular visual encoding identifiers is stored associated with each particular dwelling, and thus a lost proximity key of any dwelling is automatically replaced with a new proximity key exhibiting the same visual encoding. The lost proximity key is no longer identified in database of authorized other proximity keys 250 and will therefore not gain access. Only proximity keys, whose identification matches an identifier on database 220, i.e. is found in database of authorized master proximity keys 240 or database of authorized other proximity keys 250 enables entry.

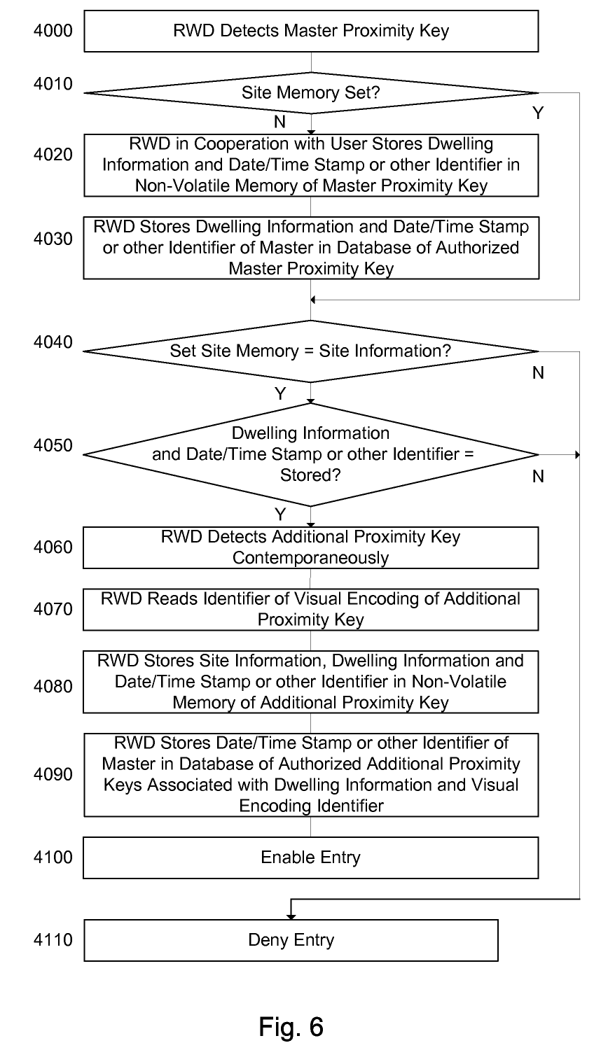

FIG. 6 illustrates a high level flow chart of the operation of the multi-dwelling RWD implemented as interphone panel 200 of FIG. 5 to authorize proximity keys in accordance with a principle of the invention. In stage 4000, RWD implemented as interphone panel 200 detects master proximity key 40. As described above, master proximity key 40 is identified by an identifier of a particular visual encoding 140.

In stage 4010, the memory location of master proximity key 40 in which site information is to be stored is checked. In the event the site information is empty, i.e. master proximity key 40 has not yet been loaded into the current database, in stage 4020, RWD implemented as interphone panel 200 in cooperation with user input, stores dwelling information and a date/time stamp, or other identifier, in a predetermined non-volatile memory of master proximity key 40. In an embodiment in which another identifier is utilized, the identifier may be optionally loaded at time of manufacture. Preferably, the identifier is not associated with the identifier of stage 1010 of FIG. 2, and thus individual dwelling access codes are not stored on database 220.

In stage 4030, RWD implemented as interphone panel 200 stores dwelling information and the date/time stamp or other identifier stored on master proximity key 40 on database of authorized master proximity keys 240.

In the event that in stage 4010 the site information is not empty, or after stage 4030, in stage 4040 the site memory stored on detected master proximity key 40 is read and compared with site information 230 stored on database 220. In the event that the site information matches, in stage 4050 dwelling information and date/time stamp or other identifier stored on master proximity key 40 is read and compared with the authorized master proximity keys of database of authorized master proximity keys 240.

In the event that in either stage 4040 the site information does not match or in stage 4050 dwelling information and date/time stamp or other identifier stored on master proximity key 40 is not found on database authorized master proximity keys 240, in stage 4110 entry is denied and the routine exits.

In the event that in stage 4050 dwelling information and date/time stamp or other identifier stored on master proximity key 40 is found on database of authorized master proximity keys 240, in stage 4060 RWD implemented as interphone panel 200 detects an additional proximity key 50 contemporaneously with master proximity key 40. As described above, additional proximity key 50 is identified by an identifier of a visual encoding not associated with master proximity key 40 and in stage 4070 the identifier of visual encoding is read by RWD implemented as interphone panel 200. A plurality of visual encodings are preferably supplied, and further preferably the plurality of visual encodings are color encodings.

In stage 4080 RWD implemented as interphone panel 200 stores site information, dwelling information and a date/time stamp or other identifier, in a predetermined non-volatile memory of additional proximity key 50. In an embodiment in which another identifier is utilized, the identifier may be optionally loaded at time of manufacture. Preferably, the identifier is not associated with the identifier of stage 1010 of FIG. 2.

In stage 4090, RWD implemented as interphone panel 200 stores the date/time stamp or other identifier stored on additional proximity key 50 associated with dwelling information and the identifier of visual encoding read in stage 4070 on database of authorized additional proximity keys 250. Preferably, only a single instance of each of the plurality of particular visual encoding identifiers is stored associated with each particular dwelling, and thus a lost proximity key of any dwelling is automatically replaced with a new proximity key exhibiting the same visual encoding.

In stage 4100, an additional proximity key 50 whose site information matches site information 230 and whose date/time stamp or other identifier, dwelling information and identifier of visual encoding is found on authorized other proximity key database 250 is enabled entry. It is further to be understood that a master proximity key 40 whose site information matches site information 230 and whose date/time stamp or other identifier and dwelling information is found on authorized master proximity key database 240 is enabled entry.

The above has been described in which a master proximity key is detected contemporaneously with an additional proximity key, however this is not meant to be limiting in any way. In one embodiment, an additional proximity key is detected within a predetermined period of the detection of a master proximity key without exceeding the scope of the invention and the term contemporaneously is intended to include such a predetermined period.

Thus, the present embodiments enable a method of visually encoding proximity keys. A particular visual encoding defines a master, and a plurality of visual encodings, different than the visual encoding defining the master proximity key, defines additional proximity keys. An identifier of the visual encoding is stored in the non-volatile memory of the proximity key as well as a unique identifier of the proximity key. In one embodiment, a plurality of master proximity keys is defined.

When an RWD is initialized, it awaits detection of a master proximity key. Upon detection of a first master proximity key, identified as a master proximity key by the visual encoding identifier stored thereon, the RWD stores the unique identifier of the master proximity key in a memory, preferably a non-volatile memory, and preferably sets a flag indicating that a master proximity key has been identified. In one embodiment, detection of a second master proximity key is ignored. In another embodiment, one or more additional master proximity keys may be similarly identified and the unique identifier stored in memory. In another embodiment, the RWD loads the master proximity key with an identifier, the identifier being used in place of the unique identifier of the master proximity key, which need not be supplied.

Authorization of additional proximity keys is accomplished in cooperation with the one or more master proximity key. Upon detection of a master proximity key and contemporaneously an additional proximity key, the additional proximity key being visually encoded differently from the master proximity key, an identifier of the visual encoding being stored therein, the RWD stores the identifier of the additional proximity key associated with the identifier of the visual encoding in an authorized key memory thereby authorizing the proximity key. Preferably, a plurality of visual encodings are supplied, and only a single proximity key of a particular visual encoding is authorized on the RWD by being stored in the authorized key memory.

In the event of a lost key, a replacement key of the same visual encoding as the lost key is obtained. Authorization, as describe above, automatically disables the lost proximity key by storing the identifier of the replacement proximity key associated with the particular visual encoding, in place of the identifier of the lost proximity key.

In a preferred embodiment, the visual encoding is by color, and thus a master proximity key is supplied exhibiting a particular color, and additional proximity keys are supplied in a plurality of colors other than that of the master proximity key. Preferably, only a single proximity key of a particular color may be authorized by the RWD, and lost proximity keys are easily replaced, and disabled, by a proximity key of the same color encoded in cooperation with the master proximity key. Visual encoding is preferred for ease of recall of the visual encoding of the lost proximity key.

Access to a multi-dwelling site is preferably performed in cooperation with an RWD. The multi-dwelling site RWD preferably does not access the unique identifier of the proximity keys utilized to access individual dwellings.

As indicated above, master proximity keys in accordance with a principle of the invention exhibit a particular visual encoding, an identifier of the visual encoding being stored therein. In one embodiment, the master proximity key, or proximity keys, of each dwelling is further encoded with site information, certain dwelling information and a date/time stamp. The certain dwelling information is encoded in cooperation with a user input, the user input identifying to the multi-dwelling RWD, or encoder, certain dwelling information such as unit number or registered name for the master proximity key. The date/time stamp stored on the master proximity key is further stored as an identifier on the authorized master proximity key database of the multi-dwelling site associated with the multi-dwelling site RWD, the date/time stamp being stored on the authorized master proximity key database associated with the certain dwelling information. In another embodiment a unique identifier is utilized in place of the date/time stamp, the unique identifier being different than the unique identifier associated with access to the dwelling. In one further embodiment the unique identifier is stored on the master proximity key as part of an initial production process, and in another embodiment the unique identifier is sourced from one of the multi-dwelling site RWD, the encoder, and the authorized master proximity key database.

Additional proximity keys for the dwelling are authorized in cooperation with master proximity key as described above. In particular, upon detection of a master proximity key, whose date/time stamp or other identifier matches a date/time stamp stored as an identifier, or other identifier, on an authorized master proximity key database, and contemporaneously an additional proximity key, the additional proximity key being visually encoded differently from the master proximity key and an identifier of the visual encoding being stored therein, the RWD, or encoder, stores on the additional proximity key a date/time stamp, site information and certain dwelling information. The RWD, or encoder, further stores on an authorized additional proximity key database the date/time stamp associated with the identifier of the visual encoding of the proximity key and the certain dwelling information. Preferably, a plurality of visual encodings are supplied, and only a single proximity key of a particular visual encoding is authorized on the RWD by being stored in the authorized proximity key database. Thus, lost proximity keys are easily replaced, and disabled, by a proximity key of the same color encoded in cooperation with the master proximity key of the particular dwelling. In another embodiment a unique identifier is utilized in place of the date/time stamp, the unique identifier being different than the unique identifier associated with access to the dwelling.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

I claim:

1. A method of proximity access control comprising:
defining a master proximity key exhibiting a particular visual encoding;
defining at least one additional proximity key exhibiting a particular visual encoding different than said particular visual encoding exhibited by said master proximity key;
detecting said master proximity key;
detecting one of said at least one additional proximity keys contemporaneously with said detected master proximity key; and
enabling said detected additional proximity key, said enabling being associated with said particular visual encoding.

2. A method according to claim 1, wherein said defining a master proximity key comprises:
visually encoding said master proximity key with said exhibited particular visual encoding; and
storing an identifier of said visual encoding on said master proximity key.

3. A method according to claim 1, wherein said defining a master proximity key further comprises:
storing a unique identification code on said master proximity key.

4. A method according to claim 1, wherein said defining at least one additional proximity key comprises:
visually encoding said at least one additional proximity key with said particular visual encoding; and
storing an identifier of said visual encoding on said at least one additional proximity key.

5. A method according to claim 1, wherein said defining at least one additional proximity key further comprises:
storing a unique identification code on said at least one additional proximity key.

6. A method according to claim 5, wherein said enabling comprises:
reading said stored unique identification code of said detected additional proximity key;
reading said identifier of said visual encoding of said detected additional proximity key; and
storing said read unique identification code associated with said read identifier of said visual encoding on an authorized proximity key database.

7. A method according to claim 6, wherein said enabling further comprises:
enabling entry responsive to said stored unique identification code.

8. A method according to claim 6, wherein in the event that said read identifier of said visual encoding of said detected additional proximity key is the same as a previously stored identifier of said visual encoding stored on said authorized key database associated with a previously stored unique identification code, said storing of said read unique identification code associated with said read identifier of said visual encoding on said authorized proximity key database disables a proximity key exhibiting said previously stored unique identification code.

9. A method according to claim 1, wherein said at least one additional proximity key comprises a plurality of additional proximity keys, said particular visual encoding of each of said plurality of additional proximity keys being different than said particular visual encoding of all others of said plurality of additional proximity keys.

10. A method according to claim 1, wherein said particular visual encoding is constituted of a particular color.

11. An access control system comprising:
a read write device;
a master proximity key exhibiting a particular visual encoding; and
at least one additional proximity key exhibiting a particular visual encoding different than said particular visual encoding exhibited by said master proximity key,
said read write device being operative to:
detect said master proximity key;
detect one of said at least one additional proximity key contemporaneously with said detected master proximity key; and
enable said detected additional proximity key associated with said particular visual encoding.

12. An access control system according to claim 11, wherein said master proximity key comprises a stored identifier of said visual encoding.

13. An access control system according to claim 11, wherein said master proximity key further comprises a stored unique identification code.

14. An access control system according to claim 11, wherein said at least one additional proximity key comprises a stored identifier of said particular visual encoding.

15. An access control system according to claim 11, wherein each of said at least one additional proximity key further comprises a stored unique identification code.

16. An access control system according to claim 15, wherein said operation to enable said detected additional proximity key comprises:
read said stored unique identification code of said detected additional proximity key;
read said stored identifier of said visual encoding of said detected additional proximity key; and
store said read unique identification code associated with said read stored identifier of said visual encoding.

17. An access control system according to claim 16, wherein said operation to enable said detected additional proximity key further comprises:
enable entry responsive to said stored read unique identification code.

18. An access control system according to claim 16, wherein in the event that said read identifier of said visual encoding of said detected additional proximity key is the same as a previously stored identifier of said visual encoding stored on said authorized key database associated with a previously stored unique identification code, said storing of said read write device of said read unique identification code associated with said read identifier of said visual encoding on said authorized proximity key database disables a proximity key exhibiting said previously stored unique identification code.

19. An access control system according to claim 15, wherein said operation to enable said detected additional proximity key comprises:
store a unique identification code on said detected additional proximity key;
read said stored identifier of said visual encoding of said detected additional proximity key; and
store said unique identification code associated with said read stored identifier of said visual encoding.

20. An access control system according to claim 11, wherein said at least one additional proximity key comprises a plurality of additional proximity keys, said particular visual encoding of each of said plurality of additional proximity keys being different than said particular visual encoding of all others of said plurality of additional proximity keys.

21. An access control system according to claim 11, wherein said particular visual encoding is constituted of a particular color.

22. A method of proximity access control for a multiple dwelling site comprising:
defining a plurality of master proximity keys exhibiting a common particular visual encoding;
storing an identifier of said visual encoding on each of said plurality of master proximity keys;
storing on each of said defined plurality of master proximity keys site information, dwelling information and one of a date/time stamp and a unique identifier;
defining a plurality of additional proximity keys each exhibiting a visual encoding different than said particular visual encoding exhibited by said plurality of master proximity keys;
storing an identifier of the respective visual encoding of each of said additional proximity keys on the respective additional proximity key;
detecting one of said plurality of master proximity keys;
detecting one of said at least one additional proximity key contemporaneously with said detected one of said master proximity keys;
reading from said one of said plurality of master proximity keys said site information, dwelling information, and said one of said date/time stamp and said unique identifier;
reading from said detected one additional proximity key said stored identifier of the respective visual encoding;
storing on said detected one additional proximity key said read site information, said dwelling information and one of a current date/time stamp and a unique identifier;
storing on a database of authorized additional proximity keys said one of said current data/time stamp and said unique identifier associated with said read dwelling information and said identifier of said visual encoding of said detected one additional proximity key; and
enabling entry responsive to said database of authorized proximity keys.

23. A method according to claim 22, wherein said enabling entry comprises:
detecting one of said at least one additional proximity keys;
reading from said detected one additional proximity key said site information, said dwelling information and said one of a current date/time stamp and a unique identifier; and
enabling entry in the event said read site information, said read dwelling information and said read one of a current date/time stamp and a unique identifier corresponds with those stored on said database.

24. A method according to claim 22, wherein said unique identifier is not used to access individual dwellings.

25. A system for access to a multiple dwelling site, said system comprising:
a read write device;
a data base associated with said read write device;
a plurality of master proximity keys, each associated with a particular dwelling of said multiple dwelling site and exhibiting a common particular visual encoding and each exhibiting a stored identifier of said visual encoding, each of said plurality of master keys further having stored thereon site information, dwelling information regarding said particular dwelling and one of a date/time stamp and a unique identifier; and
a plurality of additional proximity keys each exhibiting a visual encoding selected from a plurality of visual encodings different than said particular visual encoding exhibited by said plurality of master proximity keys and each exhibiting a stored identifier of said selected visual encoding;
said read write device being operative to:
detect one of said plurality of master proximity keys;
detect one of said at least one additional proximity key contemporaneously with said detected one of said master proximity keys;
read from said one of said plurality of master proximity keys said site information, dwelling information, and said one of said date/time stamp and said unique identifier;
read from said detected one additional proximity key said stored identifier of the respective visual encoding;
store on said detected one additional proximity key said read site information, said dwelling information and one of a current date/time stamp and a unique identifier; and
store on said database said one of said current data/time stamp and said unique identifier associated with said read dwelling information and said read identifier of said selected visual encoding of said detected one additional proximity key.

26. A system according to claim 25, wherein said database is arranged to store for each dwelling no more than one of said current data/time stamp and said unique identifier associated with each identifier of said plurality of visual encodings.

27. A system according to claim 25, wherein said read write device is further operative to:
detect one of said at least one additional proximity keys;
read from said detected one additional proximity key said site information, said dwelling information and said one of a current date/time stamp and a unique identifier; and
enable entry in the event said read site information, said read dwelling information and said read one of a current date/time stamp and a unique identifier corresponds with one of those stored on said database.

28. A system according to claim 25, wherein said unique identifier is not used to access individual dwellings.
